(19) United States
(12) Patent Application Publication
(10) Pub. No.: US 2009/0321336 A1
(43) Pub. Date: Dec. 31, 2009

(54) FILTER FOR WATER POTABILIZATION AND A PROCESS FOR REALIZATION OF THE FILTER

(75) Inventor: Giorgio Girondi, Mantova (IT)

Correspondence Address: OCCHIUTI ROHLICEK & TSAO, LLP, 10 FAWCETT STREET, CAMBRIDGE, MA, 02138, US

(73) Assignee: UFI FILTERS S.P.A., Port Mantovano (IT)

(21) Appl. No.: 12/299,552

(22) PCT Filed: Feb. 26, 2007
(86) PCT No.: PCT/EP07/51787

§ 371 Date: Jan. 7, 2009

(30) Foreign Application Priority Data
May 9, 2006 (IT) RE2006A000056

(51) Int. Cl. C02F 1/50; H05H 1/24

(52) U.S. Cl. 210/198.1; 427/569

(57) ABSTRACT

A filtering septum (3) for filtration of liquids comprises at least a first layer (30), formed from a porous structure of polymer fibres, on which molecules are inserted which comprise at least a functional group having antibacterial properties.

### TECHNICAL FIELD

The invention relates to a filter for potablilization of water, i.e. for rendering water drinkable or usable for food preparation, without any risk to human health. More in particular, the invention relates to a portable-type filter which is suitable to be used for potablilization of water coming from non-controlled sources in emergency situations, for example in cases of natural calamities or pollution of water sources.

### BACKGROUND ART

The main contaminants which might be the cause of water pollution are generally sub-divided into three categories: inorganic chemical contaminants, organic chemical contaminants and microbiological contaminants.

### Inorganic Chemical Contaminants.

ammonium ion (NH4+): this mainly derives from human and animal excreta and its presence in the water, if accompanied by unfavourable microbiological analyses, is a sure index of pollution from sewers or animal sources.

Nitrites and nitrates: these can be produced by processes of oxidation of the ammonium ion, or by phenomena consequent to the use of nitrogenous fertilizers in agriculture.

Hydrogen sulphide (H₂S): this is considered an index of organic material contamination of waters, as it can originate from sulphur contained in proteins.

Heavy metals (Cd, Cr, Pb, As, Hg, Ni, etc.).

Inorganic acids: these contribute to alteration of water pH.

### Organic Chemical Contaminants.

Hydrocarbons.

Chloroform (CHCl₃) and other methane halogenates.

Trieline, tetrachloroethylene and other halogenated solvents.

Benzene, acetone, phenols, tetrahydrofuran and other generic organic solvents.

Pesticides and Insecticides.

Plasticisers.

surface-active agents.

### Microbiological Contaminants.

These are, in general, all the pathogenic micro-organisms responsible for diseases which can cause damage to the health. They are listed in the following classes on the basis of their dimensions.

Helminths (worms)

Protozoa

Fungi

Bacteria

Viruses

In the light of the above, water can be declared suitable for potable use only when it has been analysed both chemically and microbiologically and when the concentration of contaminants is below values fixed by norms and standards.

In general water must be wholesome and clean, i.e. it must not contain micro-organisms and parasites, nor other substances, in quantities which might represent a risk for human health.

In this context, in order to replenish potable water for private users in cities and in general urban areas, large networks of water distribution are provided with plants in which collected waters are subjected to a certain number of treatments having the aim of guaranteeing its potability.

These treatments can be summarised as the following stages:

clarification: this consists in removing suspended solids, reducing water turbidity and removing the larger particles. Clarification can be performed using various methodologies, for example by means of grid and screen filtering, coagulation and flocculation, sedimentation, large-particle sand filtration, microfiltration using membrane systems.

Purification: this consists in removal of organic and inorganic chemical substances in order to improve the organoleptic characteristics of the water. Purification is prevalently achieved by adsorption on activated carbon, but in some cases can be achieved using membrane-based processes such as ultrafiltration, nano-filtration and reverse osmosis.

Disinfection: this consists in removal of pathogenic micro-organisms or in their reduction to quantities which can be considered to render them innocuous. The most-applied method is chlorination, although most recently alternative methods are being developed, such as ozonation or irradiation by means of ultra-violet rays.

Sweetening, demineralisation, removal of ions and inorganic compounds.

These are secondary processes which are generally performed using ion-exchange resin treatments, using treatments having chemical additives (lime and soda) and, less often, using reverse osmosis processes.

In emergency conditions, the majority of the industrial instruments developed for performing the above-cited water potabilization stages cannot be applied due to impediments of a technical nature.

For these applications, at present numerous small-dimension portable devices are available, which are able to perform, on a small scale, a sequence of water treatments similar to those performed in industrial plants. In the majority of cases these devices contain a plurality of discrete filtering units which are crossed in series by the water undergoing filtration.

In particular, the devices include coarse filters or deep septic filters for primary removal of suspended solids, through a pre-filtration process; thereafter chemical compounds and organic molecules are removed by adsorption on activated carbon granules or powder; finally microbic disinfection is performed by forced filtration on ceramic or polymer membranes.

These devices are essentially of two types, either with water being pumped through the filtering units, or with water filtration by force of gravity, by free fall from a tank towards the filtering units.

In both cases the devices provide good results in terms of water potabilization, but exhibit the considerable drawback of being, for the most part, rather expensive.

The aim of the present invention is to make available a filter for water potabilization which is of modest size, so as to be easily transportable and utilizable in any situation, and which is constructionally economical so as to be able to be realised in single-use disposable form, eliminating the costs connected to maintenance thereof and reducing the costs of treatment of the water.

A further aim of the invention is that the filter does not contain devices which are only electrically operating and that in general cannot be made to operate in emergency situations. In particular, the filtration of the water must be done by pumping water through the filtration system by use of a manual pump, or by force of gravity by free fall of the water from a tank positioned higher than the filtration system.

A further aim of the invention is that the filter is able to process and purify water coming from any water source accessible in an emergency situation, and thus containing contaminants which are not always clearly definable.

### DISCLOSURE OF INVENTION

These aims are achieved by the invention, which makes available an innovative filtering septum combining the properties of several materials having different characteristics, in order to be able to perform, with a single passage, several stages of the potabilization treatment of the water.

In particular, the filtering septum comprises at least a first layer of polymer fibres, which create a microporous filtering structure functioning as a barrier against chemical contaminants.

The polymer fibres of the first layer are also functionalised by the addition of molecules, typically monomers or oligomers, which comprise a functional group having anti-bacterial properties, in order to be efficient also against bacteria and pathogenic microbe particles which are contained in the water to be treated.

By antibacterial properties, we intend the ability of the functional group to combine with the transiting bacteria and microbic particles and kill them.

A functional group which has been validly shown to be effective against bacteria is the ammonium group.

The ammonium group is able to penetrate the cell membrane of micro-organisms where, according to a qualified theory, the group performs its action by creating an osmotic imbalance which leads to the swelling of the cell membrane itself up until it explodes.

Preferably the first layer of the filtering septum is made up of 400 slim and superposed layers, or sheets, made of a non-woven fabric having mean pore diameter comprised between 20 and 30 micron, and mean diameter of the fibres comprised between 10 and 20 micron, for a total exposed fibre surface of between 20 and 30 square metres. Further, it is functionalised with ammonium groups by inclusion of a methacrylic monomer [2(methacryloxy)ethyl)], trimethyl ammonium chloride.

In a preferred aspect of the invention, the filtering septum also comprises a second microporous layer of polymer fibres, which are functionalised by activated carbon in order to be effective in retaining the organic and inorganic chemical compounds present in the water to be treated.

With the term “functionalisation” of the activated carbon, it is meant that among the fibres of the second layer particles of activated carbon are distributed, which can adsorb the above-cited chemical compounds.

The activated carbon is constituted by charcoal which is activated by a special heat or chemical treatment. Preferably this will be a porous adsorbent with an internal surface which is variable between 500 and 1,500 m²/gr.

The first and second layers of the filtering septum are adjacent and are arranged reciprocally in series, in order that the flow of water to be treated can be constrained to cross firstly the second functionalised layer with activated carbon, and secondly the first functionalised layer with ammonium groups.

Preferably the second layer of polymer fibres exhibits a microporous structure having a like porosity to the first layer, with mean pore size comprised between 20 and 30 micron.

In a further preferred aspect of the invention, the filtering septum also comprises a third micoroporous layer of polymer fibres, which is destined to filter the large particles suspended in the water flow under treatment.

The third layer is arranged in series to the preceding layers, and is adjacent to the second layer, which is thus interposed between the third layer and the first layer.

In this way, the water flow to be treated can be forced to cross in order the third layer, which has a pre-filtration function, the second layer, which prevalently removes the chemical compounds, and the first layer, which prevalently filters the micro-biological contaminants.

Preferably, the third layer of polymer fibres exhibits a mean porosity which is graeter than that of the preceding layers, with a mean pore size of between 50 and 100 micron.

In a preferred aspect of the invention, each of the three layers which constitute the filtering septum of the invention is made by superposing a plurality of slim sheets of a non-woven material of polymer fibres having a thickness of between 0.1 and 0.2 mm.

Obviously each sheet exhibits a porosity which is consonant with the layer to which it belongs, and is subjected to the relative functionalising treatments independently of the other sheets in the layer.

Thanks to this solution, the process of realisation of each single layer of the filtering septum can be efficiently optimised according to the characteristics which the layer is destined to possess.

### BRIEF DESCRIPTION OF DRAWINGS

Further characteristics and advantages of the invention will better emerge from a reading of the following description, provided purely by way of non-limiting example, and aided by the accompanying FIGURE of the drawing, in which:

FIG. 1 is a schematic view of an axial section of a filter for potabilization of water according to the invention.

### BEST MODE FOR CARRYING OUT THE INVENTION

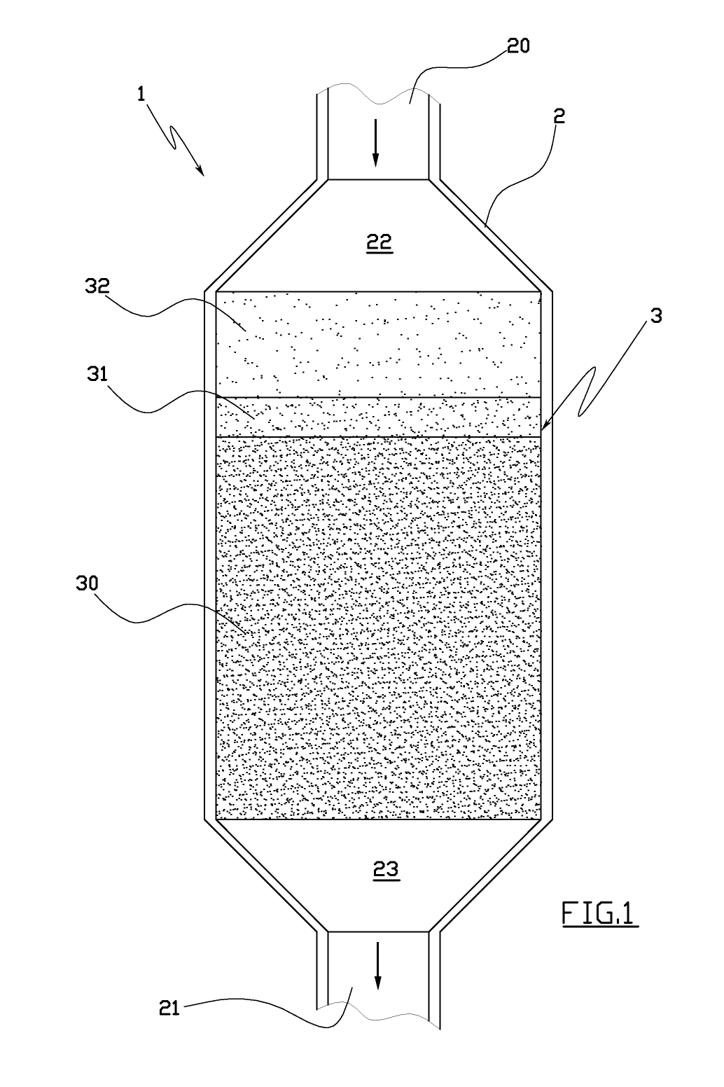

FIG. 1 illustrates a portable filter 1 of a single-use disposable type, which is suitable for use in potabilizing water coming from non-controlled sources in emergency situations.

The filter 1 comprises an external covering 2 provided with an inlet 20 for the water to be filtered, and an outlet 12 for the filtered water.

The external covering 2 contains a filtering septum 3 which divides the internal volume into two distinct chambers, a first chamber 22 placed in connection with the inlet 20 and a second chamber 23 in connection with the outlet 21.

In this way, the water which passes from the first chamber 22 to the second chamber 23 is forced to pass through the filtering septum 3, undergoing a potalibilization treatment.

As shown in FIG. 1, the filtering septum 3 comprises three adjacent filtering layers, respectively a first layer 30, a second layer 31 and a third layer 32.

The filtering layers 30, 31 and 32 are reciprocally connected in series, and are arranged internally of the filter 1 so as to be crossed in succession by the flow of water to be treated. In particular, the flow of water is constrained first to cross the third layer 32, then the second layer 31 and finally the first layer 30.

The third layer 32 prevalently functions as a pre-filter, as it removes the large-size particles and the suspended solids from the water.

The second layer 31 prevalently removes the chemical compounds and the organic molecules.

The first layer 30 prevalently disinfects the water, and removes therefrom the micro-organisms and bacteria.

In the illustrated example, the layers 30, 31 and 32 have a generally flat conformation, which makes the filtering septum 3 suitable to be axially crossed by the water to be filtered. However, the layers 30, 31 and 32 might have a toroidal geometry, and be inserted one in another, with the result that the filter could be crossed radially.

According to the invention, the first layer 30 is constituted by a micro-porous filtering structure which is made of microfibres of a polymer material, preferably polypropylene or polyamide (nylon).

The microporous structure has a mean pore diameter of about 24 micron, and the polymer fibres of which it is made are functionalised by inclusion of monomers comprising at least a functional group having anti-bacterial properties.

Preferably the functional group is an ammonium group.

In this way, the micro-porous structure retains by physical action the larger contaminants, while the added ammonium groups (added to the polymer fibres) combine with the bacteria and micro-organisms, killing them.

From the constructional point of view, the first layer 30 is formed by a group of slim sheets of non-woven material made of the polymer micro-fibres, the sheets of which are prepared separately before being superposed in a pack configuration.

Preferably the sheets are of a thickness which is comprised between 0.1 and 2 mm.

In more detail, each single sheet is realised using a melt-blown process.

In this way, by specially regulating the operative parameters of the melt-blown process, a microporous structure can be obtained having a predetermined mean porosity.

Once realised, the sheet is impregnated with a watery solution containing the monomers to be deposited on the polymer fibres thereof.

In particular, to add the above-mentioned ammonium group to the polymer fibres, the above-mentioned watery solution must contain monomers and oligomers which contain the ammonium group; these can be for example methacrylic monomers such as [2(methacryloxy)ethyl)], trimethyl ammonium chloride, or [2(methacryloxy)propyl)], trimethyl ammonium chloride, or vinyl polymers such as diallyldimethyl ammonium chloride or vinylbenzyl trimethyl ammonium chloride.

As the methacrylic monomers have generally been shown to be more reactive than the vinyl monomers, it is preferable to use a methacrylic monomer solution.

Excellent results have been achieved with a [2(methacryloxy)ethyl)], trimethyl ammonium chloride.

At this point, the sheet of non-woven material is subjected to a treatment having the aim of increasing the chemical compatibility between the monomers in solution and the polymer fibres, in order to promote the creation of chemical bonds between the monomers and the polymer fibres.

For this purpose, subjecting the sheet to a plasma treatment is particularly effective.

Plasma treatment consists in exposing the surface of the polymer material to a partially-ionized gas composed of excited atoms, molecules, ions, free radicals and other metastable particles, which is commonly known as plasma.

The plasma is produced by applying a strong electrical field to a process gas or a mixture of process gases at low pressure, up until the effect known as spark discharge takes place.

The physical process obtained consists in the collision of free electrons with the molecules of the process gas, with following dissociation of the molecules of the gas and the formation of numerous reactive species which interact with the surface of the polymer material undergoing treatment, generating free radicals on the surface thereof.

The free radicals are subjected to addition reactions, generating polymer surfaces having very different properties from those of the original material.

The gas of mixtures of gases can comprise air, nitrogen, oxygen, argon, helium, methane, ammonia and different monomers.

The interaction of the plasma with the polymer surfaces can produce various modifications in the material properties, according to the process gas used and the operative conditions adopted.

Industrially, the plasma is realised internally of a reaction chamber which is filled with the process gas, and in which the polymer substrate to be treated is located.

The reaction chamber is associated to a usual system for creating an internal vacuum, for lowering the process gas pressure down to values consonant with the adopted operative conditions.

The electrical field is generated by means of a pair of electrodes located in the reaction chamber, which can be connected either to a direct current generator or to an alternating current generator.

Alternatively, the electrical field can be obtained by means of a microwave generator or a radio-frequency generator.

In the present invention, the plasma treatment generates metastable species on the polymer surface of the non-woven material sheet, for example macroradicals, which form a chemical bond with the monomer present in the solution.

In this way, the addition of the monomer prevalently interests a slim surface portion of the non-woven material sheet being processed, up to a depth which is usually less than 1 mm. However, as the sheet is very slim indeed, it is reasonable to assume that all its fibres are sufficiently functionalised.

In particular, excellent results have been obtained by exposing the non-woven material sheet to a radio-frequency plasma of Argon gas, in pressure conditions of about 0.2 mbar, and with applied electrical field energy of about 45 J/cm².

Alternatively to the described plasma treatment, the formation of free radicals on the surface of the polymer sheet, and the consequent addition of the monomers, can also be efficiently caused by other types of treatment.

An example is a treatment in which the polymer sheet is impregnated with the monomer solution and exposed to a high-energy UV beam.

In the invention, the second layer 31 of the filtering septum 3 is constituted by a microporous structure of polymer fibres functionalised by activated carbon, which is able to adsorb the chemical compounds and the organic molecules present in the water to be treated.

The carbon is activated by a special heat treatment or chemical treatment. It is a porous adsorbent with an internal surface which is variable between 50 and 1,500 m²/gr.

The microporous structure of the second layer 31 is preferably realised in polyamide or polypropylene, and has a mean porosity which is similar to that of the first layer 30, with a mean pore size of preferably 24 micron.

The second layer 31 is also made from an assembly of slim non-woven material sheets, which are prepared separately and thereafter superposed and packed together.

In more detail, each single sheet belonging to the second layer 31 is first made by a melt-blown process.

It is then impregnated with a liquid mixture containing water and disaggregated particles of the activated carbon.

Thereafter the sheet is subjected to ultrasound waves in order to cause insertion and trapping of the activated carbon particles among the polymer fibres.

Finally, the sheet is dried at a temperature of about 60° C. in order to eliminate the water.

In this way, the particles of activated carbon are physically trapped internally of the polymer fibres of the sheet and can thus exert their effects during the filtration of the water.

The third layer 32 of the filtering septum 3 is also constituted by a micro-porous structure of polymer nanofibres, preferably polypropylene or polyamide.

In particular, the third layer 32 exhibits a medium-to-high porosity, with a mean pore size preferably comprised between 50 and 100 micron, in order to block the larger-size particles and the solids suspended in the water to be treated, mainly functioning as a pre-filter for the successive layers 31 and 30. As with the other layers, the third layer 32 can be effectively realised by superposing a group of sheets of non-woven material made of polymer fibres, obtained via a melt-blown process.

In conformity with the destination of use of the filter 1, it is envisaged that the passage of the water through the filtering septum 3 must be done by pumping using a manual pump, or simply by force of gravity, by free fall of the water from a tank positioned at a higher level than the filter 1 itself.

Further, it is preferable that the filter be able to process about 20 litres of water before becoming unusable. In this way, by providing a filtering battery made up of several filters 1 (about twenty in number) arranged in parallel, a module can be created which would be able to satisfy the minimum needs of a small number of people (about four people) for a relatively short time (about 6 days). This means an overall production of 480-500 litres of water.

To realise a filter 1 having a filtering capacity of about 20 litres, the filtering layers 30, 31 and 32 of the filtering septum 3 are preferably made in cylindrical body conformations, having a same diameter and different thicknesses.

In particular, the diameter is preferably not less than 6 cm; the thickness of the first layer 30 comprised between 10 and 30 cm; the thickness of the second layer 31 comprised between 1 and 3 cm; and the thickness of the third layer 32 comprised between 2 and 6 cm.

Obviously by “thickness” we refer to the size of the layers 30, 31 and 32 which develops parallel to the direction in which the layers 30, 31 and 32 are crossed by the flow of the water to be filtered.

Excellent results have been obtained with filtering septums 3 having a diameter of about 6 cm, in which the first layer 30 has a thickness of about 19 cm, the second layer 31 a thickness of about 2 cm and the third layer 32 has a thickness of about 4 cm.

In this way, a very compact filtering septum 3 is obtained, with an overall thickness of about 25 cm, and able to remove up to 99.99% of the bacterial load contained in the water to be treated.

Naturally the dimensions suggested herein are merely indicative in nature, and can be very considerably subject to variation, for example when a filtering septum 3 having a different filtering capacity is to be constructed.

1-52. (canceled)

53. A filtering septum for potablilization of liquids, comprising at least a first layer formed by a porous structure of polymer fibres, on which polymer fibres molecules comprising at least a functional group having anti-bacterial properties are inserted, the at least a functional group having anti-bacterial properties being an ammonium group, and said molecules are comprised in a monomer and an oligomer group; wherein said molecules are methacrylic monomers or vinyl monomers.

54. The septum of claim 53, wherein the molecules are comprised in a group constituted by: [2(methacryloxy)ethyl)] trimethyl ammonium chloride, [2(methacryloxy)propyl)] trimethyl ammonium chloride, diallyldimethyl ammonium chloride and vinylbenzyl trimethyl ammonium chloride.

55. The septum of claim 53, wherein the molecules are molecules of [2(methacryloxy)ethyl)] trimethyl ammonium chloride.

56. The septum of claim 53, wherein the polymer fibres which form the first layer are polypropylene fibres or polyamide fibres.

57. The septum of claim 53, wherein the first layer exhibits a mean pore size comprised between 20 and 30 micron.

58. The septum of claim 53, wherein the first layer exhibits a thickness comprised between 10 and 30 cm.

59. The septum of claim 53, comprising at least a further layer formed by a porous structure of polymer fibres, among which fibres particles of activated carbon are inserted.

60. The septum of claim 59, wherein the activated carbon is a porous adsorbent having an internal surface which is variable between 500 and 1,500 m²/gr.

61. The septum of claim 59, wherein the first layer and the further layer are arranged in such a way as to be crossed in series by the fluid to be filtered.

62. The septum of claim 59, wherein the further layer exhibits a mean pore diameter comprised between 20 and 30 micron.

63. The septum of claim 59, wherein the further layer exhibits a thickness comprised between 1 and 3 cm.

64. The septum of claim 53, comprising at least a further layer formed by a porous structure of polymer fibres, having a porosity which is greater than a porosity of the first layer.

65. The septum of claim 64, wherein the first layer and the further layer are arranged in such a way as to be crossed in series by the fluid to be filtered.

66. The septum of claim 64, wherein the further layer exhibits a mean pore diameter comprised between 50 and 100 micron.

67. The septum of claim 64, wherein the further layer has a thickness comprised between 2 and 6 cm.

68. The septum of claim 53, comprising at least a second layer formed by a porous structure of polymer fibres, between which polymer fibres particles of activated carbon are inserted, at least a third layer formed by a porous structure of polymer fibres, which exhibits a porosity which is higher than a porosity of the first layer.

69. The septum of claim 68, wherein the first layer, the second layer and the third layer are arranged in such a way as to crossed in series by the fluid to be filtered, the second layer being interposed between the first layer and the third layer.

70. A filter for fluids comprising an external covering provided with at least an inlet for the fluid to be filtered and an outlet of the fluid after filtration, and provided with a filtering septum which separates an internal volume of the covering into two discrete chambers, of which chambers a first chamber is connected with the inlet and a second chamber is connected with the outlet; the filtering septum including at least a first layer formed by a porous structure of polymer fibres, on which polymer fibres molecules comprising at least a functional group having anti-bacterial properties are inserted, the at least a functional group having anti-bacterial properties being an ammonium group, and said molecules are comprised in a monomer and an oligomer group; wherein said molecules are methacrylic monomers or vinyl monomers.

71. A process for manufacturing a filtering septum for filtration of fluids, comprising a stage of realising at least a first layer formed by a porous structure of polymer fibres, the polymer fibres being functionalised by an insertion of molecules which comprise at least a functional group having antibacterial properties, said polymer fibres being fibres made of polypropylene or polyamide, and said functional group having anti-bacterial properties being an ammonium group, and said molecules being comprised in a group constituted by monomers and oligomers, wherein the molecules are methacrylic monomers or vinyl monomers.

72. The process of claim 71, wherein the molecules are comprised in a group constituted by: [2(methacryloxy)ethyl)), trimethyl ammonium chloride, [2(methacryloxy)propyl)] trimethyl ammonium chloride, diallyldimethyl ammonium chloride and vinylbenzyl trimethyl ammonium chloride.

73. The process of claim 71, wherein the molecules are molecules of [2(methacryloxy)ethyl)], trimethyl ammonium chloride.

74. The process of claim 71, wherein the manufacturing of the first layer comprises stages of:
realising a group of sheets made of non-woven material from the polymer fibres;
functionalising each of the sheets by inserting thereon the molecules containing at least a functional group having anti-bacterial properties; and
making a superposed pack of the sheets in order to obtain the first layer.

75. The process of claim 74, wherein the sheets have a thickness comprised between 0.1 and 2 mm.

76. The process of claim 74; wherein the sheets exhibit a mean pore size which is comprised between 20 and 30 micron.

77. The process of claim 74, wherein the sheets made of polymer fibres are singly obtained by means of a melt-blown process.

78. The process of claim 74, wherein the functionalisation of each sheet of polymer fibre comprises:
impregnating the sheet with a liquid solution containing the molecules, and thereafter
subjecting the sheet to a surface treatment aimed at promoting a creation of chemical bonds between the molecules and the polymer fibres.

79. The process of claim 78, wherein the surface treatment consists in exposing the sheet of polymer fibres to ultraviolet rays.

80. The process of claim 78, wherein the surface treatment consists in exposing the sheet of polymer fibre to a plasma of a predetermined gas or mixture of gases.

81. The process of claim 80 wherein the gas or mixture of gases is chosen, from a group constituted by air, nitrogen, oxygen, argon, helium, methane and ammonia.

82. The process of claim 80, wherein the gas is argon.

83. The process of claim 82, wherein the argon plasma is obtained in an environment in which a pressure is about 0.2 mbar.

84. The process of claim 82, wherein the plasma is obtained by subjecting the argon to an electrical field having an energy of about 45J/cm².

85. The process of claim 71, comprising further stages of:
realising a further layer formed by a porous structure of polymer fibres, which polymer fibres are functionalised by means of insertion of particles of activated carbon between the fibres; and
coupling the further layer to the first layer in order to make the further layer and the first layer suitable for being crossed in series by the liquid to be filtered.

86. The process of claim 85 wherein the polymer fibres are fibres of polypropylene or polyamide.

87. The process of claim 85, wherein the activated carbon is a porous adsorbent with an internal surface which can vary between 500 and 1,500 m²/gr.

88. The process of claim 85, wherein the manufacturing of the further layer comprises stages of:
realising a group of sheets made of non-woven material from the polymer fibres;
inserting the particles of activated carbon in the polymer fibres of each of the sheets, and making a superposed pack of the sheets in order to obtain the further layer.

89. The process of claim 88, wherein the sheets of polymer material have a thickness comprised between 0.1 and 2 mm.

90. The process of claim 88, wherein the second layer has a mean pore size comprised between 20 and 30 micron.

91. The process of claim 88, wherein the sheets of polymer fibre are singly obtained by means of a melt-blown process.

92. The process of claim 88, wherein the insertion of the particles of activated carbon between the polymer fibres of each sheet of fibres comprises stages of:
impregnating the sheet with a liquid mixture containing particles of the activated carbon, subjecting the sheet to ultrasound waves, and
drying the sheet.

93. The process of claim 71, comprising further stages of:
realising a further layer formed by a porous structure of polymer fibres having a porosity which is greater than a porosity of the first layer, and
coupling the further layer and the first layer in such a way as to make them suitable for being crossed in series by the liquid to be filtered.

94. The process of claim 93, wherein the polymer fibres are fibres of polypropylene or polyamide.

95. The process of claim 93, wherein the third layer has a porosity comprised between 50 and 100 micron.

96. The process of claim 93, Wherein the manufacture of the further layer comprises stages of:
realising a group of sheets made of non-woven material from the polymer fibres having a greater porosity than the porosity of the first layer, and
making a superposed pack of the sheets in order to obtain the further layer.

97. The process of claim 71, comprising further stages of:
realising a second layer formed by a porous structure of polymer fibres, which polymer fibres are functionalised by means of insertion of particles of activated carbon between the fibres;
realising a third layer formed by a porous structure of polymer fibres having a porosity which is greater than the porosity of the first layer and coupling the first layer, the second layer and the third layer in such a way as to be made suitable to be crossed in series by the liquid to be filtered, the second layer being interposed between the first layer and the third layer.
